(19) United States
(12) Patent Application Publication
(10) Pub. No.: US 2004/0107806 A1
(43) Pub. Date: Jun. 10, 2004

(54) Tool assembly with interchangeable iris actuating frame

(76) Inventor: Thomas A. Gruber, Rochester, NY (US)

Correspondence Address: Stephen B. Salai, Esq., Harter, Secrest & Emery LLP, 1600 Bausch & Lomb Place, Rochester, NY, 14604-2711, US

(21) Appl. No.: 10/315,883

(22) Filed: Dec. 10, 2002

(51) Int. Cl. B26D 1/00; B26B 27/00

(52) U.S. Cl. 83/13; 30/90.1; 30/94; 30/123

(57) ABSTRACT

A tool assembly having a pair of pivotally interconnected handles and a cooperating, interchangeable iris frame. The iris frame can be exchanged with an alternative iris frame for cutting wires, pipes, stripping wires, engaging faceted elements such as nuts and bolts, cutting threads, as well as swaging. The iris frame retains a plurality of blades operably moveable between a retracted position and an extended position by actuation of the handles. One of the handles and the iris frame can include gearing for effectively adjusting a force exerted by the blades.

### FIELD OF THE INVENTION

The present invention relates to a multi purpose tool, and more particularly to a tool assembly having a power driven and hand held configuration with an interchangeable iris frame for selectively providing an iris cutter, iris wire stripper, an iris swage, iris pipe cutting, iris threading, and iris nut and bolt configurations.

### BACKGROUND OF THE INVENTION

Although power driven and hand-held tools perform a variety of functions, traditional functions include cutting wire and stripping insulation from a length of the wire as well as swaging.

Typically, wire is cut by forcing two relatively hardened opposing edges toward each other, with the portion of the wire to be cut disposed between the opposing edges. As the opposing edges are brought together, the metal is deformed thereby severing the wire. However, the deformation of the metal often forms a relatively sharp edge at each of the severed surfaces of the wire. These sharp surfaces can injure a person who then handles the cut wire.

The sharp edges produced by the cutting action also occur when cords or cables of other materials are severed by such wire cutters. For example, cutting relatively thick monofilament fishing line cut with traditional wire cutters produces a sharp edge on each end of the cut line.

In addition, for those users relying upon the wire cutting function, there is typically an associated requirement to strip installation from selected lengths of the wire. Therefore, it would be beneficial for a wire-cutting device to also provide wire-stripping and other capabilities. The need exists for a tool assembly, which can cut wires of various gauges, without forming sharp severed ends. The need also exists for a hand-held tool that can readily provide cutting, stripping, swaging, thread cutting, and nut and bolt loosening and tightening functions. A further need exists for such a tool assembly in a power driven and band held configuration.

### SUMMARY OF THE INVENTION

The tool assembly includes a power driven and a hand held configuration having an interchangeable iris frames, for selectively cutting, stripping, swaging cylindrical members, cutting and threading pipe, and tightening and loosening nuts and bolts.

A configuration of the invention includes a pair of handles pivotally connected to be moveable between an open position and a closed position. At least one of the handles is configured to removeably receive an iris frame. The iris frame includes at least three blades moveable between a retracted position and an extended position. The iris frame can be constructed to include cutting blades, stripping blades or swaging blades. The iris frame and the handles are selected such that upon movement of the handles from the open position to the closed position, the blades of the iris cutter are moved to the extended position.

The cutting of cylindrical members, such as wires, lines or cords, with the present invention reduces the formation of residual sharp edges on the cut member. That is, the severed ends of the cut piece tend to form a single, relatively flat apex, rather than an extended sharp edge.

In a further configuration, the tool can be manually actuated or power driven by any means, wherein the power includes, but is not limited to electrical, hydraulic, pneumatic, gasoline, diesel, or mechanical drives.

### BRIEF DESCRIPTION OF THE DRAWINGS

FIG. 1 is a perspective view of one configuration of the hand held tool.

FIG. 2 is a partial side elevational view showing pivotal interconnection of a pair of handles.

FIG. 3 is an elevational view of a first configuration of an iris frame.

FIG. 4 is a cross sectional view taken along lines 4-4 of FIG. 3.

FIG. 5 is an enlarged view of a portion of the iris frame.

FIG. 6 is an elevational view of an alternative iris frame.

FIG. 7 is a cross sectional view of a handle incorporating a motor drive.

FIG. 8 is a side elevational view of a contacting surface of a moveable blade.

FIG. 9 is a top plan view of the contacting surface of the moveable blade of FIG. 8.

FIG. 10 is a side elevational view of a ridged contacting surface of a moveable blade.

FIG. 11 is a top plan view of the contacting surface of the moveable blade of FIG. 10.

### DETAILED DESCRIPTION OF THE PREFERRED EMBODIMENT

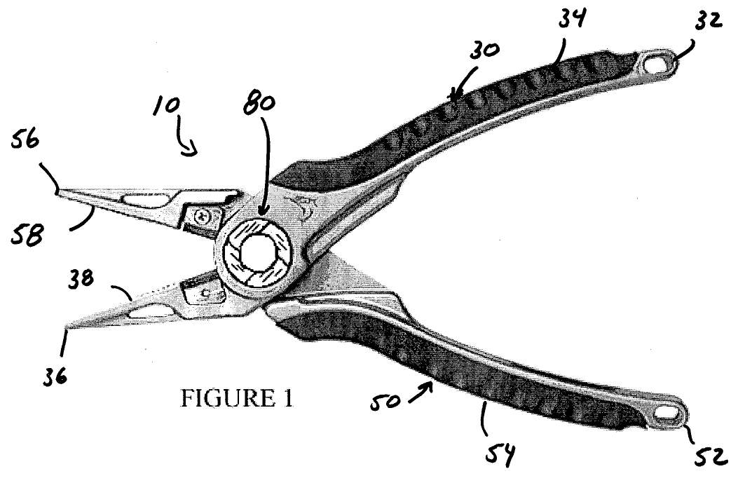

Referring to FIG. 1, a configuration of a tool assembly 10 in the hand held configuration and encompassing the present invention is shown. For purposes of description, the tool assembly 10 is set forth as a manually actuated hand held apparatus. However, it is understood the tool assembly 10 can be power driven by any means. Further, the tool assembly 10 can be bench (or table) mounted. Generally, the tool assembly 10 includes a pair of handles 30,50 and an iris frame 80.

In the manually actuated hand held configuration, handle 30 includes a pair of terminal ends 32, 36 and an intermediate grip 34. Handle 50 includes a pair of terminal ends 52, 56 and an intermediate grip 54. In one configuration, the handles are pivotally interconnected intermediate the terminal ends, as seen in FIG. 1. However, it is understood the handles can be pivotally interconnected adjacent to, or at their terminal ends.

A bias mechanism (not shown) can be located between the handles 30, 50, to urge the handles to the open position. The bias mechanism can be any of a variety of configurations including coil springs, leaf springs, flexible fingers and pistons. However, it is understood the bias mechanism is not required.

In the configuration shown in FIG. 1, the handles 30, 50 are interconnected intermediate the terminal ends to define a pair of jaws 38, 58 moveable in concert with corresponding grips 34, 54 between an open position and a closed position.

The jaws 38, 58 can be configured to perform any of a variety of functions, including pinching, gripping, cutting, and can have any of a variety of configurations including needle, flat, snub, curved or straight. The specific formation of the jaws 38, 58 is independent of the iris frame 80.

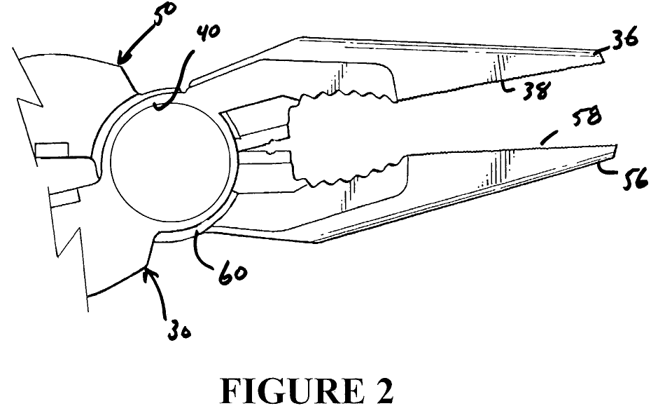

The pivotal interconnection of the handles 30, 50 can be accomplished in any of a variety of constructions. For example, one handle can include an aperture, and the remaining handle includes a sleeve sized to be cooperatively received in the aperture. Alternatively, referring to FIG. 2, each handle can includes a sleeve 40,60, wherein the sleeves are sized to cooperatively or telescopically engage. Typically, the smaller diameter sleeve is concentric with and is circumscribed by an aperture in the corresponding handle.

In one configuration, the first handle includes the sleeve projecting from an adjacent portion of the handle. The sleeve includes a peripheral slot, wherein the slot extends about 30 to 135 degrees of the sleeve. The sleeve can also include a locating stop, or shoulder on an inner surface of the sleeve. The locating stop can be circumferential or defined by a plurality of discrete tabs. The sleeve is concentric with and circumscribed by the aperture extending through the first handle.

The second handle includes the aperture sized to receive the sleeve. In addition, the second handle includes a tab sized to project into the peripheral slot. However, it is understood the second handle could include a detent or recess for engaging a tab projecting radially outward through the peripheral slot. Thus, the handles pivot about a pivot axis concentric with the sleeve and the aperture.

In a further configuration, it is contemplated one of the handles can be substituted with a tabletop or bench mount, wherein the remaining handle pivots relative to the tabletop mount between the open position and the closed position. Such construction would allow increased force as a larger lever arm on the handle can be employed.

The sleeve 40 is sized to operably receive the iris frame 80. The iris frame 80 is operably located by contacting the locating stop on the sleeve. The iris frame 80 is sized to be disposed within the sleeve 40 and either operably engage the inwardly projecting tab from the first or second handle, or alternatively include a radially projecting finger (tab) 82 which engages the corresponding recess or shoulder in the first or second handle. The iris frame 80 is constructed to removably engage the handles 30, 50, such that the iris frame can be removed from the handles and replaced with an alternative iris frame. The iris frame 80 can be operatively retained relative to the handle by any of a variety of mechanisms such as threaded fastener, cams, catcher tabs or moveable locking arms.

The relative amount of movement between a retracted position and an extended position of the iris frame 80 can be set by limiters on the handles or by the connection of the iris frame to the handles.

Although the sleeve and corresponding apertures have been described for cooperatively engaging the handles, it is understood any of a variety of mechanically equivalent structures can be employed.

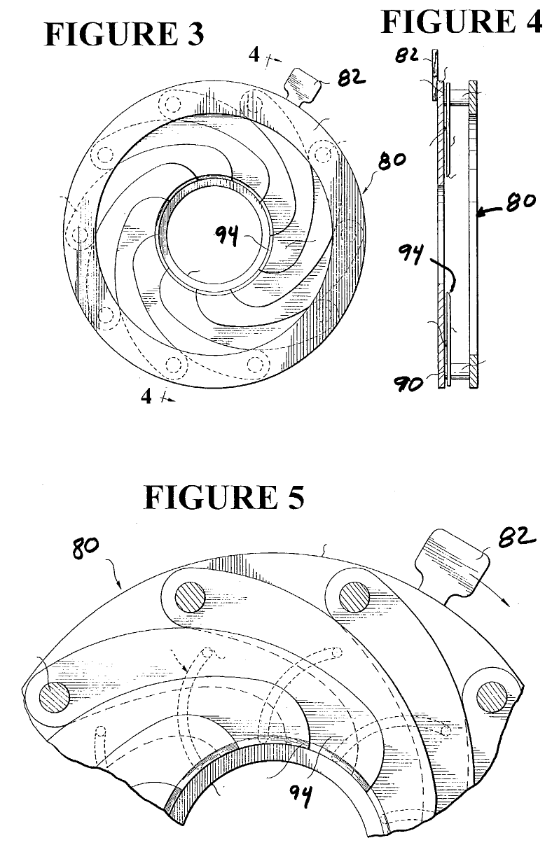

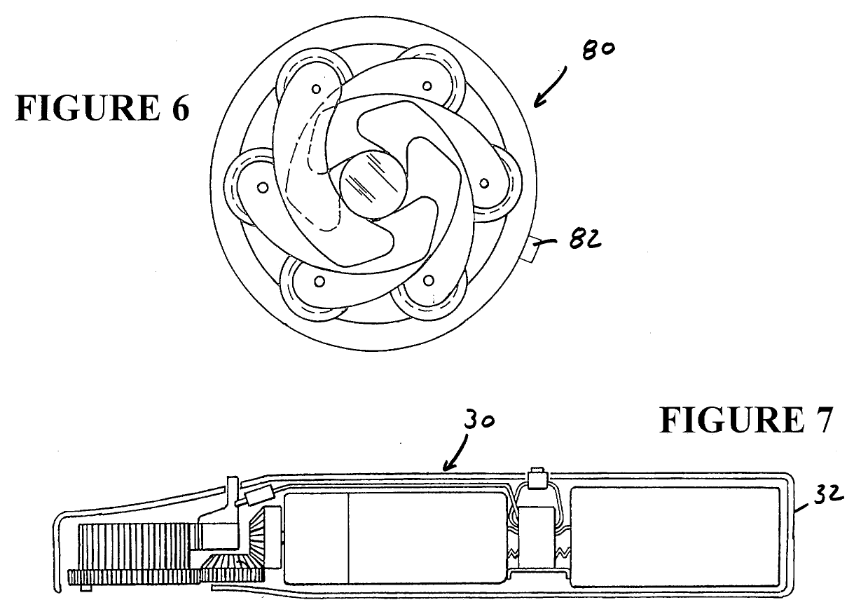

The iris frame 80 includes a frame 90 and a plurality, and preferably at least three moveable blades 94. However, it is understood that more than three blades 94 may be used depending upon the intended material to be cut or swaged. The moveable blades 94 are connected to the frame 90 between a retracted position (FIG. 1 and 3) and an extended position (FIG. 6). The iris frame 80 can be of any of a variety of mechanisms such as that shown in U.S. Pat. Nos. 3,903,598; 3,954,003; 4,475,938; 5,223,277; and 2,717,440, each of which is hereby incorporated by reference. Thus, this iris frame 80 defines a frame and an actuating iris, wherein the actuating iris includes the blades 94. Actuation of the blades 94 relative to the frame 90 is driven by relative movement of the handles.

The iris frame 80, used in conjunction with the handles 30, 50 can incorporate any of a variety of blade constructions, such as cutting, stripping or swaging. That is, one iris frame 80 can include moveable blades such as cutting blades; a second iris frame can include moveable blades such as gapped or recessed blades for stripping insulation, and a third iris frame can include moveable blades such as swaging blades. The blades 94 can be hardened or tempered metal with relatively sharp engaging/cutting surfaces or flatter surfaces for performing swaging functions. The blades can also be designed to be self sharpening for cutting and stripping applications. It is also contemplated that the movable blades can include a gripping or contact surface for engaging a multifaceted surface of such as a nut or bolt head. Alternatively, the blades 94 can be configured to cut or form threads in the cylindrical member engaged by the tool. Further, the desired action of the blades can be enhanced by limiting or controlling the position of the blades in the extended position. That is, the extended position of the blades may define a gap or passage through the iris cutters, wherein the gap is formed by limiting motion of the blades, or including recesses in the respective blades.

In a further configuration, the iris frame 80 can include selectively actuatable first gearing and a second gearing. It is contemplated the first and second gearing can be selected to provide different torques in response to actuation. That is, each gearing can define a different gearing ratio and thus different force corresponding to a user applied force on the handle.

In one configuration, the iris frame 80 defines two sides, such that one side includes the first gearing and the second side includes the second gearing. The iris frame 80 is constructed such that either side can be operably received in the sleeve 40. Thus, the user can select which gearing to employ, by merely operably locating the appropriate side of the iris frame in the mount. Thus, to operably engage the alternative gearing, an operator merely removes the iris frame, and reinserts the iris frame to engage the alternative gearing. Alternatively, the iris frame 80 can define halves such that one half defines one half the periphery of the iris frame, and a second half defines the remaining periphery. Thus, the iris frame has a top half and a bottom half. Each half can include respective gearing.

In a further construction, the handle or sleeve can be configured to include a selecting lever to operably connect one of the gearings to the motive force (manual or power).

In an alternative construction, the pivotal connection of the handles can be offset from the location of the iris frame. In this construction, a sliding pin or other transfer member connects the second handle to the iris frame 80 to provide the motive force for actuating the moveable elements. Thus, the iris frame 80 can be intermediate the pivot point of the handler and the hand grip; at the pivot point of the handles, or spaced from the pivot point to locate the pivot point intermediate the iris frame and the hand grips 34, 54.

In a further construction, the handles 30, 50 can be sized and configured so that the first handle receives and operably engages a first iris frame and the second handle receives and operably engages a second iris frame. For example, the first iris frame can include cutting blades and the second iris frame can include stripping blades. Thus, an insulated wire can be simultaneously cut by the cutting blades and the insulation stripped by the stripping blades. It is understood other combinations or iris frames (and blades) can be employed, as well as incorporating the selectable gearing.

In either configuration, gearing can be disposed within or cooperatively engage the iris frame to increase or decrease the amount of torque exerted by the moveable blades.

In operation, as the cutting blades move (rotate) relative to the cylindrical member (wire) to be cut, the material of the wire is generally actually displaced uniformly about the periphery of the wire, thereby reducing the tendency to form a single sharp edge.

It is understood the profile of the blades can be selected to provide a desired resulting cutting surface, wherein the profile can depend upon the material to be cut, the number of blades and the gearing of the iris frame. That is, the blades can have a beveled or angled surface for cutting the material. Further, the stripping or swaging blades may include recesses, such that upon the blades reaching the extended position, a limited amount of penetration is provided, or a swaging diameter is defined.

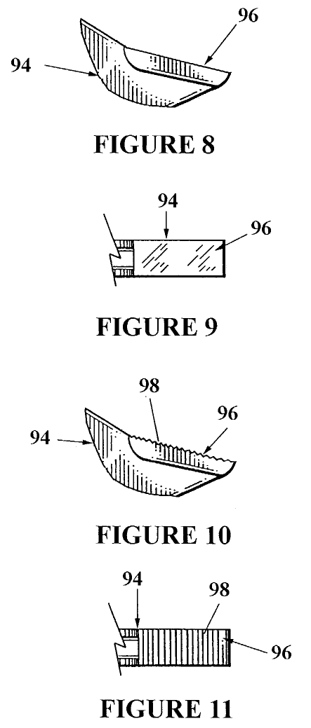

In a further configuration, it is contemplated the blades 94 can be constructed to perform a variety of additional functions. These functions can include releasably and nondestructively engaging fasteners or rotatable elements such as nuts, bolts having any of a variety of configurations including hex head or two, three or more facets. That is, as seen in FIGS. 8 and 9, the blades 94 can have a contacting surface 96 including generally planar facets selected to cooperatively engage a corresponding surface of a fastener, rather than a cutting edge for severing material.

Alternatively, it is contemplated the blades 94 can include contacting surfaces 96 having a plurality of ridges 98 extending generally parallel to an elongate member disposed within the iris frame. That is, the blades 94 have a pipe gripping surface for engaging a member within the iris frame 80 such that upon moving the iris frame to the extended position, the handles can be rotated about an axis thereby rotating the captured member.

In another configuration, the iris frame 80 is configured to contain thread cutting surfaces. In this configuration, the tool assembly is used to cut new, or repair existing threads on cylindrical members such as plastic and/or metal pipe. Upon operable engagement of the thread cutting surfaces with cylindrical member, rotation of the cylindrical member is initiated, by rotating the tool or the cylindrical member to repair or form the threads. As the parameters of the threads, such as pitch and height, are defined by the thread cutting surfaces, and each iris frame can include at least one set of thread cutting surfaces, the iris frames can be interchanged to allow for formation or repair of any of a variety of thread parameters. In addition, it is understood the thread cutting surfaces can be adapted to engage of cylindrical member of given diameter, or a range of diameters.

The tool assembly handles can be set to a specified opening widths via the stops, which were previously described, or through “vice-grip” style locking handles while cutting threads or cutting pipes. The number of movable blades in a given iris frame 80 is at least partially determined by the intended use of the blades 94. That is, whether the blades 94 will be used for cutting material or engaging a multifaceted surface to provide for rotation. Thus, the blades 94 may have a relatively thin or sharpened contacting surface for engaging the material disposed within the iris frame, or the blades may have a relatively wide or large contacting surface for engaging the elements disposed within the iris frame. While the invention has been described in conjunction with specific embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

In the claims:

1. A tool assembly, comprising:
(a) a elongate first handle having a first hand grip;
(b) a elongate second handle having a second hand grip, the second handle pivotally connected about a pivot axis to the first handle and moveable between a spaced open position and an adjacent closed position; and
(c) an iris frame operably connected to at least one of the first handle and the second handle, the iris cutter having at least three blades movable between a retracted position and an extended position, the blades in the retracted position with the handles in the open position, and the blades in the extended position with the handles in the closed position.

2. The tool assembly of claim 1, further comprising a stop on one of the handles and the iris frame, the stop sized to limit movement of the blades toward the actuated position.

3. The tool assembly of claim 2, wherein the stop is moveable to a plurality of positions.

4. The tool assembly of claim 1, wherein the iris cutter is removably connected to the first handle and the second handle.

5. The tool assembly of claim 1, wherein the iris frame is concentric with the pivot axis.

6. The tool assembly of claim 1, wherein the iris frame is eccentric with the pivot axis.

7. The tool assembly of claim 1, wherein the blades are sized to define an aperture in the extended position.

8. The tool assembly of claim 1, wherein the blades are one of cutting blades, stripping blades, thread cutting and swaging blades.

9. The tool assembly of claim 1, wherein the blades define a contacting surface having a plurality of facets.

10. The tool assembly of claim 9, wherein the contacting surface includes a plurality of ridges.

11. The tool assembly of claim 1, further comprising one of an electric motor, pneumatic motor or hydraulic motor operably connected to the iris frame to move the blades from the retracted position to the extended position.

12. The assembly of claim 1, further comprising a second iris frame operably connected to a remaining one of the first handle and the second handle.

13. The assembly of claim 12, wherein the iris frame and the second iris frame are simultaneously actuated from the retracted position to the extended position.

14. The assembly of claim 1, wherein the iris frame includes a first side having a first gearing connected to the blades, and a second side having a different second gearing connected to the blades.

15. A hand-held cutter, comprising:
(a) a first handle;
(b) a second handle pivotally connected to the first handle and moveable between an open spaced position and a closed adjacent position, the second handle including an iris frame receiving aperture;
(c) an iris frame sized to be operably received in the iris frame receiving aperture, the iris frame including at least three blades, the blades moveable between a retracted position and an extended position; and
(d) an actuating surface on the first handle for moving the blades from the retracted position to the extended position.

16. The hand-held cutter of claim 15, wherein the blades are one of cutting blades, stripping blades, thread cutting and swaging blades.

17. The hand-held cutter of claim 15, further comprising retaining means for releasably retaining the iris cutter in the iris cutter receiving aperture.

18. The hand-held cutter of claim 15, further comprising a second iris frame having a closed down aperture different than a close down aperture of the first iris cutter.

19. The hand-held cutter of claim 15, wherein the first handle includes a second iris frame receiving aperture and a second iris frame disposed within the second iris frame receiving aperture.

20. An iris cutting assembly, comprising:
(a) a first arm;
(b) a second arm pivotally connected to the first arm, the first and the second arm moveable between a first position and a second position, one of the first arm and the second arms including a mounting socket;
(c) an iris frame releasably connected to the mounting socket, the iris frame including at least three blades moveable between an extended position and a retracted position, the iris frame including gearing connected to at least one of the blades for moving the blades from the retracted position to the extended position; and
(d) a coupling interconnecting the iris frame and at least one of the arms to transfer a motive force from the handle.

21. A method cutting a cylindrical member with a hand held tool, comprising:
(a) disposing a length of the cylindrical member through an iris frame having at least three blades moveable between a retracted position and an extended position, the iris frame carried by a handle; and
(b) moving the handle relative to a second handle from an open position to a closed position to move the blades from the retracted position to the extended position, and cut the cylindrical member.

22. The method of claim 21, further comprising removing the iris frame and placing a different second iris frame in the handle.

23. The method of claim 21, further comprising manually moving the handle relative to the second handle.

24. The method of claim 21, further comprising operably connecting a power source to one of the handle and the first handle to move the handle relative to the second handle.
